(19) United States
(12) Patent Application Publication
(10) Pub. No.: US 2005/0089604 A1
(43) Pub. Date: Apr. 28, 2005

(54) Ice cream chip

(76) Inventor: Jacqueline Pastore, Suffern, NY (US)

Correspondence Address: STANLEY H. KREMEN, 4 LENAPE LANE, EAST BRUNSWICK, NJ, 08816, US

(21) Appl. No.: 10/974,899

(22) Filed: Oct. 27, 2004

Related U.S. Application Data
(60) Provisional application No. 60/481,571, filed on Oct. 28, 2003.

(51) Int. Cl. A23G 9/00

(52) U.S. Cl. 426/101

(57) ABSTRACT

A unique “edible utensil” specifically designed for eating ice cream in a new and “fun” manner. This invention allows the consumer to eat ice cream as though it were “chips and dip”. The chips will be any shape or size as long as they can serve the function of scooping ice cream without breaking and allowing for the consumer to hold the chip between his fingers so as to enable him to scoop the ice cream from a container.

### CROSS REFERENCE TO RELATED APPLICATIONS

This utility patent application (hereinafter the Present Application) is the non-provisional counterpart of U.S. Provisional Patent Application No. 60/481,571 (hereinafter the Provisional Application) filed on Oct. 28, 2003. The Present Application claims priority to the Provisional Application. The Provisional Application is incorporated by reference in its entirety into the Present Application.

### BACKGROUND

Ice cream and confections contained in pastry horns or cups have been eaten by consumers since at least the beginning of the twentieth century. In 1907, a US patent for a machine to make such pastries was awarded to Jacob Abrahams of Boston, Mass. (U.S. Pat. No. 841,211). Since probably before then, various configured ice cream cones have been regularly consumed. Originally, an ice cream cone was a pastry having a simple conical shape that is at least partially filled with ice cream (or other confectionery filling). Eventually, ice cream cones were able to have different shapes and still be called ice cream cones. The term was applied to virtually any edible cup shaped pastry that was grasped on the bottom and permitted the ice cream to be eaten from the top. The pastry comprising the cone would have either a sweet or neutral taste, and could be formed from a variety of doughs. Ice cream sandwiches have also been around for a long time. Here, a slab of ice cream is sandwiched between two wafers, and the entire sandwich is consumed. Ice cream sandwiches traditionally took the form either of a rectangular prism or a cylinder. Neither ice cream cones nor ice cream sandwiches were bite sized nor did they permit ice cream or any other confectionery filling to be scooped.

More recently, edible chips were designed for scooping more fluid foods. Some of these included saddle shaped potato chips for dipping and triangular and oval shaped tortilla chips. Tostitos® brand tortilla chips™ are sold as Scoops®, a flower shaped dipping chip that forms a bite sized cup which can be grasped between the thumb and forefinger. Fritos® brand Scoops® are boat shaped cups used for the same purpose. Bugles® are bite sized conical chips that can be grasped on the pointed end between the thumb and forefinger, and can be used to scoop dipped foods. These are not pastries nor cookies. They have a definitive taste that is not sweet nor neutral. They cannot be used to scoop a hard semi-solid material like ice cream, as the act of scooping will break the chip and leave its fragments in the ice cream.

There is a consumers' need for a sweet bite sized crisp cookie chip that can be grasped between the thumb and forefinger and can be used to scoop materials such as ice cream without breaking. Such chips can be sold stand alone or in a sealed package pre-filled with frozen ice cream. The consumer can then eat the filled chip in a single mouthful.

### CLASSIFICATION OF CURVED SURFACES

“A surface is generated by a line . . . which moves according to some law. Surfaces may thus be divided into two general classes:
(1) those which can be generated by a moving straight line and
(2) those which can be generated only by a moving curved line.
   The first are called RULED SURFACES; the second, DOUBLE-CURVED SURFACES.” (French, Thomas E. & Vierck, Charles J., “Graphic Science and Design,” Third Edition, McGraw-Hill, Inc., 1970).

Cones and cylinders are examples of solid (or hollow) objects having ruled surfaces. The present invention discloses a chip having a double-curved surface.

### SUMMARY OF THE INVENTION

The inventor has devised an edible utensil specifically designed for eating ice cream in a new manner. This invention allows the consumer to eat the ice cream as though it were “chips and dip” by using the disclosed ice cream chips. The chips serve the function of scooping ice cream without breaking and allowing for the consumer to hold the chip between his fingers so as to enable him to scoop ice cream from a container. Preferably, the chips are sweet and bite sized. In one embodiment, the chips are stand-alone utensils to be used by the consumer to scoop ice cream. In another embodiment, the chips are packaged already pre-filled with ice cream. Of course, any other filling (such as cannoli or other confectionery) may be scooped or served with the chip. The invention will allow the chips to be packaged for sale by themselves, filled with ice cream, or in combination with an ice cream cup incorporated into the package design.

The Ice Cream Chips are formed into uniquely shaped edible scoops or spoons from standard ice cream cone recipes available for sugar, wafer and waffle type cones. Any shape will do as long as consumers are able to hold it between their fingers in a direction perpendicular to the direction of scooping. They can scoop the ice cream into their mouths with the chip.

### BRIEF DESCRIPTION OF THE DRAWINGS

FIG. 1 is a top plan view of the ice cream chip.

FIG. 2 is a side elevation view of the ice cream chip.

FIG. 3 is an isometric view of the ice cream chip also showing the scoop direction.

FIG. 4 is an isometric view of the ice cream chip also showing the reference planar axes.

FIG. 5 shows an ice cream chip being grasped by a consumer.

FIG. 6 shows an ice cream chip filled with ice cream that is being grasped by a consumer.

FIG. 7 shows how an ice cream chip can scoop a small amount of ice cream from an ice cream bowl.

### DETAILED DESCRIPTION

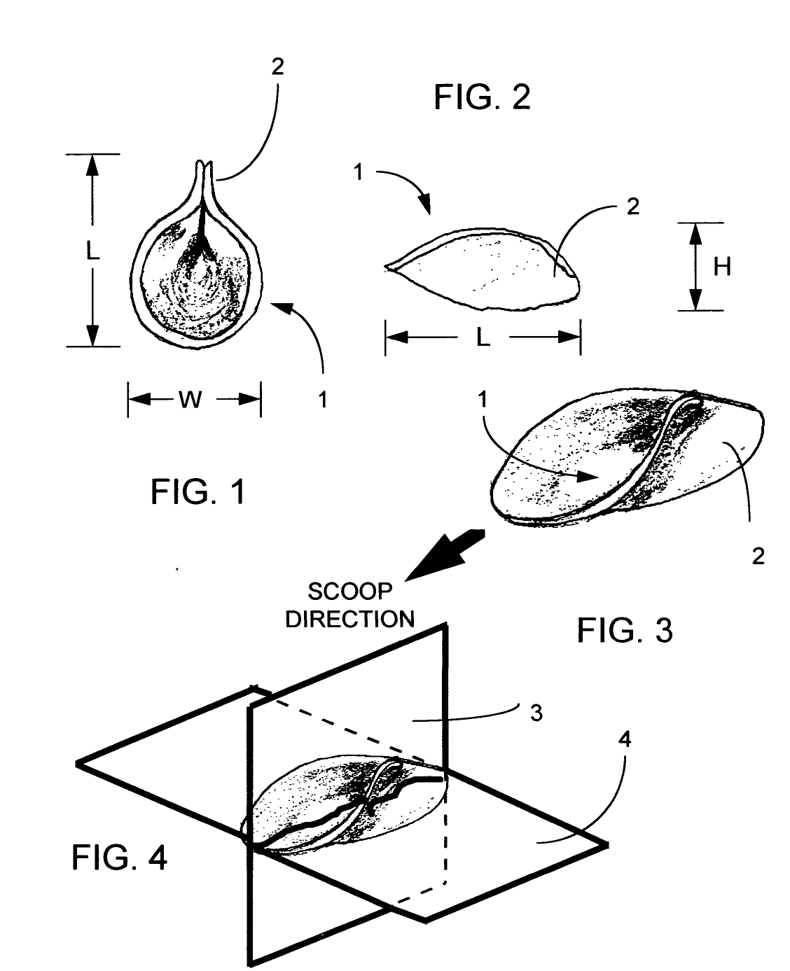

The disclosed invention is a unitary edible crisp pastry, preferably sweet, that can be formed from an oval or elliptical shaped sheet of dough by first rolling the sheet and then folding or pinching one end of the sheet. The resulting pastry is baked so as to maintain the shape and be crisp. The pastry is thick and rigid enough so as not to break when scooping ice cream. The shape of the pastry is unique and novel regardless of how it is formed. It can be seen in FIGS. 1, 2, and 3. FIG. 1 shows a top plan view of the pastry or chip; FIG. 2 shows a side elevation view of the chip; and, FIG. 3 shows an isometric view of the chip. Although the chip is a single unitary utensil, it has a complex shape. It comprises a bowl shaped portion, 1, to contain the ice cream or confectionery filling and a grasping portion, 2, to allow the utensil to be held between two fingers. As shown in FIG. 4, it has a reference planar longitudinal axis, 3, parallel to the scoop direction and a reference planar latitude axis perpendicular to the longitudinal axis 4, both planar axes passing through the chip. The utensil is grasped and held between the thumb and forefinger such that an axis through and orthogonal to both fingers is essentially perpendicular to the longitudinal axis of the chip. Ideally, the chips dimensions are:
along the longitudinal axis, 3, the length L=1½ inches;
along the latitude axis, 4, the width W=1% inches; and,
the height H=½ inch.
   A chip of these dimensions may be consumed in a single mouthful. FIG. 3 also shows the scooping direction along the longitudinal axis.

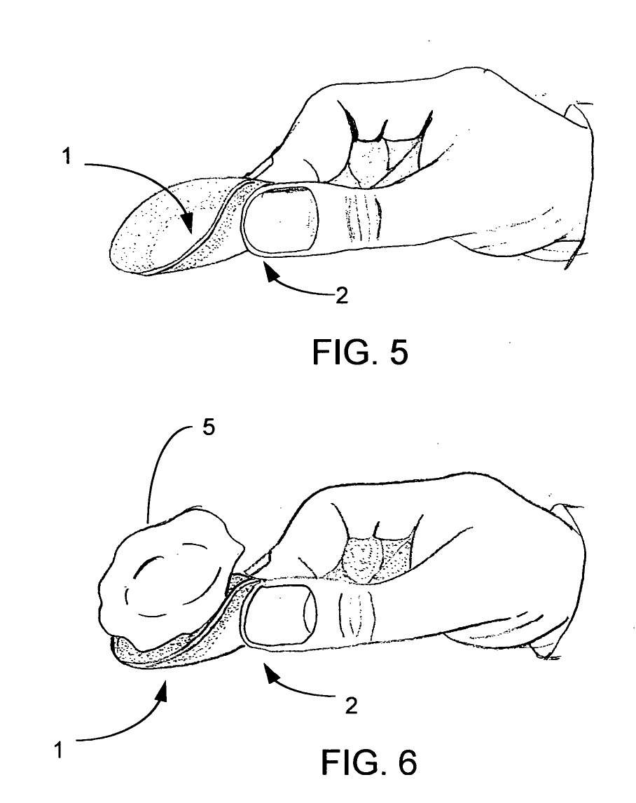

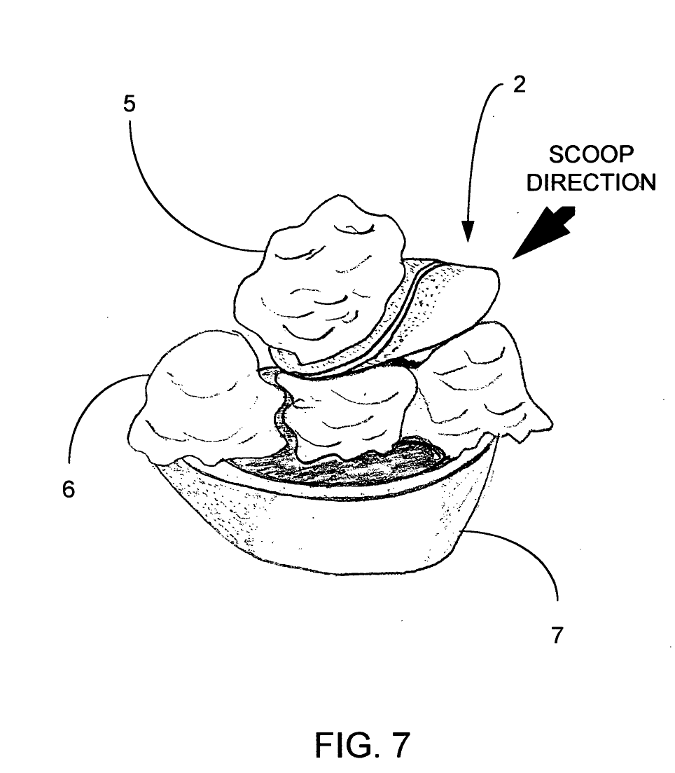

FIG. 5 shows how the chip is grasped at the grasping portion, 2, between the thumb and forefinger. The unique shape of the chip allows the chip to be held so that the grasping force is essentially perpendicular to the scooping direction. The hand then exerts a force along the longitudinal axis or scooping direction. FIG. 6 shows the bowl shaped portion, 1, filled with ice cream or confectionery filling, 5. FIG. 7 shows how the chip may be moved into a bowl, 7, filled with ice cream (or other filling) 6, so that a portion of ice cream, 5, can be scooped into the chip.

The figures show that the grasping portion, 2, is pinched such that the inside surfaces of the pastry are touching. Although this represents the preferred embodiment, a small gap can exist in the grasping direction as long as the chip may be held securely so that scooping may occur in a direction essentially perpendicular to the grasping direction.

The chip can also be sold pre-filled and packaged (possibly in cellophane). If ice cream is used, the entire package is frozen. The consumer can then consume the chip and the filling in a single mouthful.

1. An edible crisp unitary pastry having a double-curvature and having a planar longitudinal axis and a planar latitude axis perpendicular to the longitudinal axis, said pastry comprising:
a. a bowl shaped portion able to contain ice cream or other filling, said bowl shaped portion being open on one side of the axis perpendicular to the longitudinal axis and closed on the other side of that axis; and,
b. a grasping portion attached to an end of the bowl shaped portion that permits the pastry to be held at the grasping portion between the thumb and another finger of the same hand, such that a grasping force is essentially perpendicular to the longitudinal axis and essentially parallel to the latitude axis.

2. The pastry of claim 1 that is sufficiently crisp to enable a scooping force to be applied to the pastry at the grasping portion by the thumb and another finger of the same hand, such force being parallel to the longitudinal axis, so as to push the bowl portion into a large quantity of ice cream or confectionery filling and to scoop a portion of said ice cream or confectionery filling into the bowl portion without breaking the pastry.

3. The pastry of claim 1 wherein the bowl portion is flared on an end positioned opposite to the end that is attached to the grasping portion.

4. The pastry of claim 1 wherein the pastry has a sweet taste.

5. The pastry of claim 1 wherein the bowl portion is filled with ice cream or confectionery filling.

6. An edible crisp unitary pastry that is formed from a circular, elliptical, or oval sheet of dough by:
a. folding or pinching an end of the sheet of dough along a planar axis; and
b. rolling another end of the sheet of dough along the same planar axis;
wherein, once the dough is baked, it can be held at the folded or pinched end between the thumb and another finger of the same hand, such that a grasping force is essentially perpendicular to the planar axis.

7. The pastry of claim 6 that is additionally formed by flaring the rolled end of the sheet of dough.

8. The pastry of claim 6 that is sufficiently crisp to enable a scooping force to be applied to the pastry at the folded or pinched end by the thumb and another finger of the same hand, such force being parallel to the planar axis, so as to push the bowl portion into a large quantity of ice cream or confectionery filling and to scoop a portion of said ice cream or confectionery filling into the pastry without breaking the pastry.

9. The pastry of claim 6 wherein the dough has a sweet taste.

10. The pastry of claim 6 wherein the rolled end is filled with ice cream or confectionery filling.

11. An edible crisp unitary pastry having a double-curvature and having a planar longitudinal axis and a planar latitude axis perpendicular to the longitudinal axis, said pastry comprising:
a. a containing means to contain ice cream or other filling, said containing means being open on one side of the width axis and closed on the other side of the width axis; and,
b. a grasping means attached to an end of the containing means that permits the pastry to be held at the grasping means between the thumb and another finger of the same hand, such that a grasping force is essentially perpendicular to the longitudinal axis and essentially parallel to the width axis.

12. The pastry of claim 11 that is sufficiently crisp to enable a scooping force to be applied to the pastry at the grasping means by the thumb and another finger of the same hand, such force being parallel to the longitudinal axis, so as to push the containing means into a large quantity of ice cream or confectionery filling and to scoop a portion of said ice cream or confectionery filling into the containing means without breaking the pastry.

13. The pastry of claim 11 wherein the containing means is flared on an end positioned opposite to the end that is attached to the grasping means.

14. The pastry of claim 11 wherein the pastry has a sweet taste.

15. The pastry of claim 11 wherein the containing means is filled with ice cream or confectionery filling.
